(19) United States
(12) Patent Application Publication
(10) Pub. No.: US 2011/0110747 A1
(43) Pub. Date: May 12, 2011

(54) APPARATUS FOR AND METHOD OF TRIMMING OF PERFECT BOUND BOOKS

(76) Inventor: Jeffrey D. Marsh, Foristell, MO (US)

(21) Appl. No.: 12/944,315

(22) Filed: Nov. 11, 2010

Related U.S. Application Data
(60) Provisional application No. 61/260,210, filed on Nov. 11, 2009.

(51) Int. Cl. B42C 11/00; B42B 9/00

(52) U.S. Cl. 412/1; 412/11; 412/16

(57) ABSTRACT

Apparatus for and a method of determining and correcting the position and angularity of an edge of a book to be trimmed relative to a shearing plane is disclosed. The book is movable toward and away from the shearing plane and is rotatable about a rotary axis. A pair of spaced sensors generate an output signal indicative of the edge being proximate each the sensor so that upon each sensor generating its signal at substantially the same time thus indicating that the edge is substantially parallel to the shearing plane and so that if one sensors senses the edge before the other thus indicating that the edge is oriented at an angle relative to the shearing plane. A computer control system corrects the angle and vertically positions the edge so that a predetermined trim line for that edge is substantially in register with the shearing plane.

### CROSS-REFERENCE TO RELATED APPLICATIONS

This application relates to and claims priority to U.S. Provisional Patent Application No. 61/260,210 filed Nov. 11, 2009, and incorporates such application by reference in its entirety.

### STATEMENT REGARDING FEDERALLY SPONSORED RESEARCH OR DEVELOPMENT

Not Applicable.

### BACKGROUND OF THE DISCLOSURE

As described in my prior U.S. Pat. Nos. 6,193,458, 6,443,682 and 7,014,182, in U.S. Pat. No. 5,694,823 to Westra et al., and as described in my above-noted U.S. patent application Ser. No. 12/576,923, trimming of a perfect bound book may be accomplished using a one knife trimmer. Such trimmers require that the book be turned relative to the blade so that the blade may be actuated so as to trim the excess margins of the book, typically along three sides or edges of the book. These trimmed edges are typically along the side edge of the book that is parallel to the spine of the book and at the top and bottom edges of the book. Generally, it is highly desirable that the trimmed edge along the side of the book opposite the spine be parallel to the spine and that the top and bottom edges of the book be perpendicular to the spine and the side edge.

While efforts have been made to insure that the book block (i.e., the interior text pages of the book) and the bound book prior to trimming are firmly held in a known position during the binding operation so that predetermined amounts of the margins of the book may be trimmed and so that the trimmed edges of the book are substantially orthogonal, it has been found that, for a variety of reasons, the book may be presented to the trimming blade at an angle and/or in a position that may not result in the orthogonal trimming of the edges of the book or may not result in the predetermined margins being trimmed from the book. Of course, such non-orthogonal trimmed edges and improper trim margins adversely affect the appearance of the finished book and may adversely affect its salability.

For example, in my above-noted U.S. Pat. No. 6,928,914, the book is held in a book holder or clamp, as indicated by reference character 35 in the '914 patent, which grips the untrimmed book along its spine and which rotates the book through three positions in which the side, top and bottom edges of the book are positioned to be sheared by the single shear blade. With the untrimmed book positioned in this book holder, the spine of the book was intended to be held firmly against a rigid block 78 so that the spine was in the same plane as the rigid block. This book holder or clamp clamped the book between an anvil 76 and a movable gripping plate 81, as perhaps best shown in FIG. 10 of my '914 patent. A similar book gripping holder or clamp was used in the apparatus shown in my other above-identified issued patents and in my co-pending U.S. patent application Ser. No. 12/576,923 and in my co-pending PCT Application No. PCT/US2010/045,708, both of which are incorporated by reference herein in their entirety. However, with such book holders, the book may not always be properly positioned therein, both in its intended angular relation to the holder and with regard to its lateral placement in the holder. Of course, such errors in angular and/or in lateral placement could lead to the trimmed book not having orthogonal trimmed edges or may result in improper amounts being trimmed from the book.

More specifically, as shown in FIGS. 9-12 and as described in Paragraph 71 of my U.S. patent application Ser. No. 12/576,923, the book B is held by an indexing clamp 95 that has a fixed clamp jaw 97 and a clamp jaw 99 movable toward and away from the fixed jaw by means of a fluid cylinder 101, preferably an air cylinder. Between jaws 97 and 99, a bearing surface 103 is provided which bears against the spine S of the bound book B such that the spine and the abutting face of bearing surface 103 are co-planar. With the spine of the book bearing against surface 103, and with clamp 95 gripping the book along its spine, the angular position of the book held by clamp 95 is known to the computer control system CS. Again, if the spine of the book is not properly positioned on surface 103 or if the book is not firmly held by clamp 95, the book may be at some slight angle with respect to the bearing surface and hence to the shear plane of shear blade 189. If the book is so held by clamp 95 at such an angle, all of edges of the book may be misaligned relative to the shear blade such that the trimmed side edge of the trimmed book may not be parallel to the spine of the book and such that the trimmed top and bottom edges are not be perpendicular to the spine and to the side edge.

In addition, when the bound but untrimmed book B is placed in indexing clamp 95, the lateral position of the book (e.g., as indicated by a centerline extending between the spine and the side of the book parallel to the spine) relative to the clamp should be such that the centerline of the book and the horizontal axis of rotation of clamp 95 are substantially in the same vertical plane. As shown in FIGS. 9-12 and as described in Paragraph 73 of my U.S. patent application Ser. No. 12/576,923, trim indexing clamp 95 is rotatable about this horizontal axis by means of an indexing motor 115, preferably a stepper motor under control of computer system CS. As further described in Paragraph 73, switches 118a, 118b, and 118c are mounted relative to the horizontal rotational axis of indexing clamp 95 for stopping rotation of the indexing clamp at a first predetermined rotary position (as shown in FIG. 10) so as to position a first side of the book to be trimmed, and then for stopping rotation of the indexing clamp at second rotary position (as shown in FIG. 11) for trimming a second side of the book, and then for stopping rotation of the indexing clamp at a third rotary position for trimming a third side of the book so that two sides of the book (i.e., the top and bottom edges of the finished book) are perpendicular to the spine S and to the longitudinal side parallel to the spine. After the indexing clamp is rotated to one of its above-described rotary positions for trimming either the top or bottom side of the book, the indexing clamp and the book held thereby are lowered a predetermined amount into trim clamp 135 by means of vertical drive 105 so that the book is accurately positioned relative to the horizontal shearing plane of shear blade 189 so as trim a predetermined amount from that trim margin of that particular book. However, if the book is not properly positioned in indexing clamp 95, the correct amount of the book's trim margin along that side of the book will not be trimmed. Further, as the indexing clamp is rotated to present the other top or bottom side of the book to be trimmed and as the indexing clamp is moved vertically to its predetermined trim position relative to blade 189, an incorrect amount of the margin will be trimmed because the book is not properly positioned in lateral direction within the indexing clamp.

Thus, there has been a longstanding problem in trimming books with a single knife trimmer in that the book may not be properly positioned in the book holder or indexing clamp 95 in its desired angular position and/or in its desired its lateral position with respect to the indexing clamp. This has resulted in the book not being properly trimmed and/or in non-orthogonal side edges of the book.

### SUMMARY OF THE DISCLOSURE

Apparatus for determining and correcting an angularity difference between an edge of a book to be trimmed and a shearing plane and the intended angularity of such edge relative to the shearing plane is disclosed. The book is generally rectangular and has a spine, a side edge opposite the spine that is generally to parallel to the spine. The book further has two end edges extending generally orthogonally to the side edge and to the spine. The book edges each has a predetermined trim line associated therewith such that if each of the book edges is trimmed along its respective trim line the finished book will be of a predetermined finished size with the end edges of the book being substantially perpendicular to the spine and to the side edge. The book is movable toward and away from the shearing plane by a drive controlled by a computer control system and is rotatable about a rotary axis by a rotary drive controlled by the computer control system. The apparatus comprises a pair of sensors stationaryily mounted at a known distance relative to the shearing plane for sensing a first edge of the book proximate each the sensor as the first edge is moved toward the shearing plane. The sensors are spaced apart from one another a known distance and each of the sensors generates an output signal indicative of the first edge being proximate each the sensor so that upon the first edge being sensed substantially simultaneously by the sensors thus indicating to the computer control system that the first edge is substantially parallel to the shearing plane and so that if one of the output signals is generated before the other thus indicating that the first edge is oriented at an angle relative to the shearing plane whereupon the computer control system effects operation of the rotary drive to correct for the angle so that the trim line associated with the first edge may be positioned substantially in register with the shearing plane.

A method of trimming a book is disclosed where the book has a spine, a side edge generally parallel to the spine and end edges at each end of the book generally perpendicular to the spine and to the side edge. The method comprises the steps of gripping the book along its spine and rotating the book so as to present one of the edges to be trimmed. The book is moved toward a shearing blade having a shearing plane along which the blade will trim an edge of the book. The position of the last-the edge relative to the shearing plane is sensed at two spaced locations equidistant from the shearing plane and the angle of the last-the edge relative to the shearing plane is determined. If the angle is greater than a predetermined angle, then the book is rotated relative to the shearing plane so as to align a predetermined trim line associated with the last-the edge to be substantially in register with the shearing plane.

Objects and features of the present disclosure will be in part apparent and in part described in the instant disclosure.

### BRIEF DESCRIPTION OF THE DRAWINGS

FIG. 1 is a perspective view of a print on demand (POD) book printing, binding and trimming apparatus of the present disclosure;

FIG. 2 is a perspective view of a page accumulator/fixture, which is part of the apparatus shown in FIG. 1, illustrated in its raised, page accumulation position for receiving pages printed by a page printer and for forming a book block thereon;

FIG. 3 is another perspective view of the page accumulator/fixture in its raised, page accumulation position illustrating an adhesive application station and a binding station therebelow;

FIG. 4 is another perspective view of the accumulator/fixture similar to

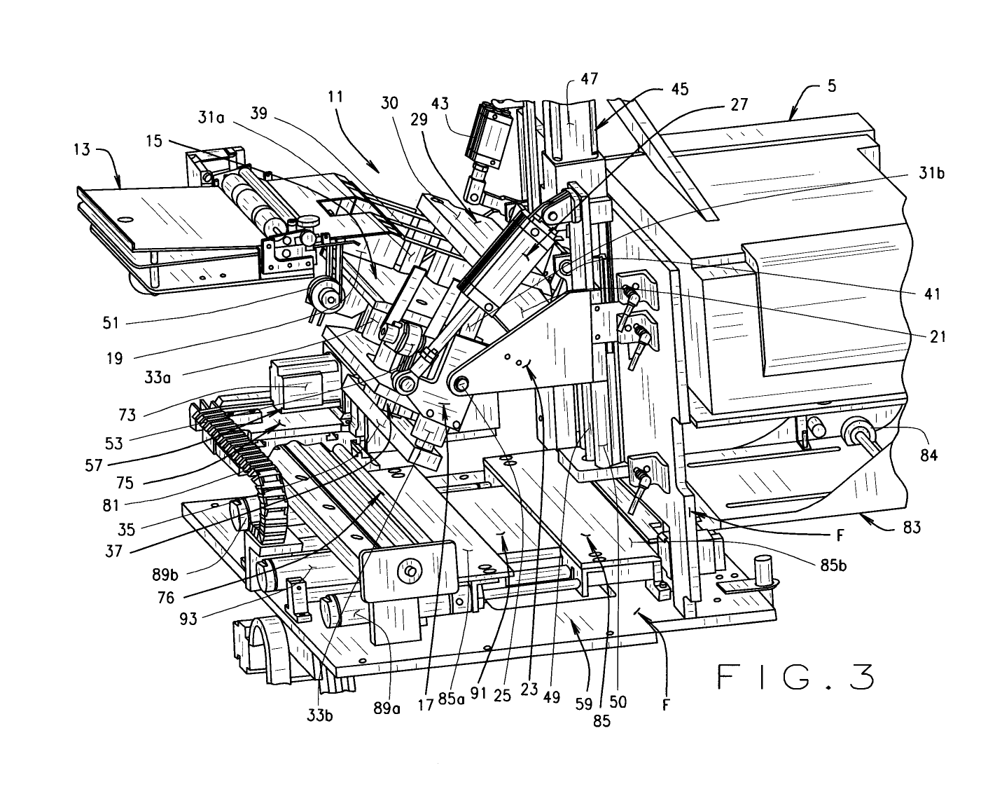

FIG. 3 showing the accumulation a book block in the accumulator/fixture, with one edge of the book block constituting the spine engageable with a book block stop plate and with another edge in engagement with a side of the accumulator such that the book block is accurately positioned in the accumulator/fixture;

FIG. 5 is still another perspective view of the accumulator/fixture in which the book block has been clamped to the bed of the accumulator/fixture by an accumulator clamp, in which the book block stop plate has been moved to a retracted position, and in which the accumulator has been moved (rotated) to a second or vertical position in which the book block is vertical with the spine of the book extending below the fixture;

FIG. 6 is a perspective view of the adhesive application station shown in FIG. 3 having a roughener for roughening the spine of the book block and a glue pot or adhesive reservoir which contains a bath of a liquid adhesive (preferably a liquefied hot melt adhesive) and which has a rotary driven adhesive application drum or wheel partially immersed in the adhesive for applying a coating of adhesive to the spine of the book block, with the roughener and the adhesive reservoir being movable lengthwise of the spine of a book block positioned at the adhesive application station to roughen the spine and then to apply adhesive to the roughened spine;

FIG. 7 is an right end elevational view of the accumulator/fixture and book block on a somewhat enlarged scale with the spine of the book block positioned at the adhesive application station for the application of adhesive to the spine with the spine spaced from the uppermost peripheral surface of the adhesive application drum by a gap;

FIG. 8 is a perspective view of the accumulator/fixture holding the book block vertically at the binding station after adhesive has been applied to the spine, the binding station having a binding clamp engageable with a cover (shown in phantom) positioned above the binding clamp for clamping the cover to the spine and to the sides of the book block proximate the spine thereby to bind the cover to the spine of the book block;

FIG. 9 is a perspective view of the binding station with the binding clamp in its open position and with the book block being held by the accumulator/fixture clamp along the margin of the book block opposite the spine so that the accumulator/fixture may lower the bound book through the binding station so as to deliver the bound book to an indexing clamp for trimming of the margins of the book by a trimming station;

FIG. 10 is a perspective view of the trimming station with the indexing clamp holding the bound book in a known position along the spine of the book, with one edge (e.g., the major edge opposite the spine) positioned within the trimming station for having the margin along this major edge trimmed from the book by a trimming blade to a predetermined dimension;

FIG. 11 is another perspective view of the trimming station with the indexing book clamp having moved (rotated) the book from the position shown in FIG. 10 to another position in which one of the minor edges of the book is positioned within the trimming station for having a margin trimmed from this one minor edge by the trimming blade;

FIG. 12 is still another perspective view of the trimming station with the indexing book holder having moved (rotated) from the position shown in FIG. 11 to another position in which the other minor edge of the book is positioned to be lowered in the trimming station for having a margin trimmed from this other minor edge so that the finished book is of a predetermined, finished size;

FIG. 13 is a cross sectional view of the adhesive application station illustrating a rotary adhesive application drum as it is partially immersed in a reservoir or bath of liquid hot melt adhesive and illustrating a coating of adhesive coating the peripheral surface of the drum, and further illustrating a standing wave of increased thickness of the adhesive on the upper regions of the drum for application to the spine of the book block;

FIG. 14 is a rear perspective view of the trimming station having an mechanical book clamp and an mechanical shear;

FIG. 15 is a top plan view of the index clamp positioning a bound book in the book clamp and further illustrating the shear;

FIG. 16 is a perspective view of the book clamp in its retracted position, with only the drive shaft of the clamp electric motor show so as to better illustrate the construction and operation of the book clamp;

FIG. 17 is a perspective view of the shear assembly with certain parts broken away for illustrative purposes so as to better illustrate the construction and operation of the shear;

FIG. 18 is a perspective view of a typical print on demand perfect bound book illustrating the book block, the cover bound to the book block along the spine of the book block and along the spine of the book, and illustrating the trim margins to be trimmed from one major dimension side of the book opposite the spine and from the top and bottom sides of the book with the top and bottom sides of the book being substantially perpendicular (orthogonal) to the side and the spine of the book; and

FIG. 19 is a diagrammatic view of a bound untrimmed book held by indexing clamp 95 with the spine S of the book being disposed at an angle θ with respect to the surface 103 of the indexing clamp and with the book being laterally offset by the offset distance z from its centered position where the axis of rotation AR of the book is substantially coplanar with the center reference point RP of the book, and with this figure further illustrating the book as it is lowered into trim clamp 135 equipped with a pair of spaced sensors S1 and S2 mounted relative to the trim clamp for sensing the edge of the book to be trimmed so that the angle of the book can be determined and so that the lateral displacement of the book relative to the axis of rotation AR of the indexing clamp may be determined thus allowing a computer control system to correct or compensate for such angular and/or lateral misplacement of the book relative to the indexing clamp.

Corresponding reference characters indicate corresponding parts throughout the several views of the drawings.

### DESCRIPTION OF PREFERRED EMBODIMENTS

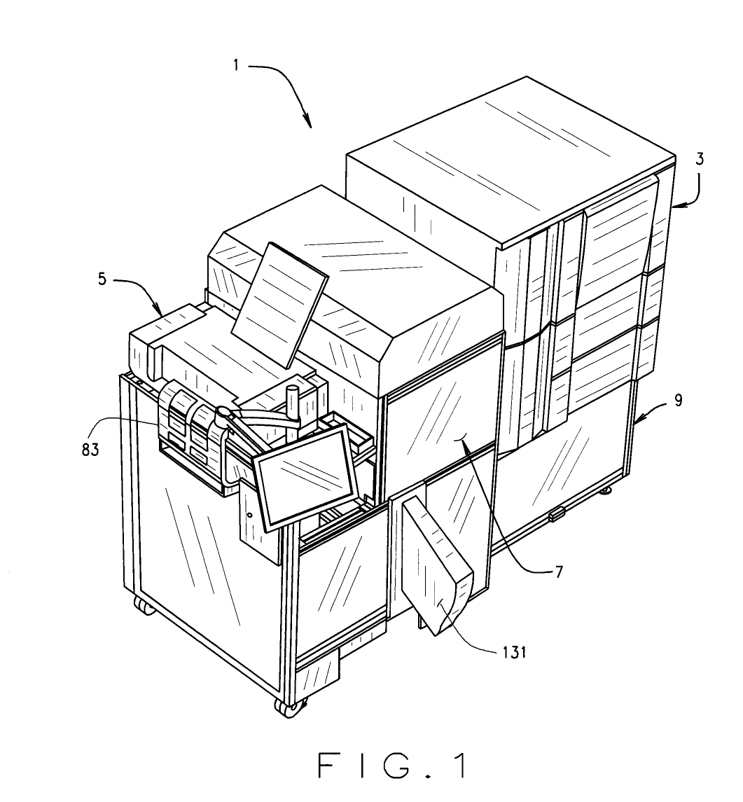

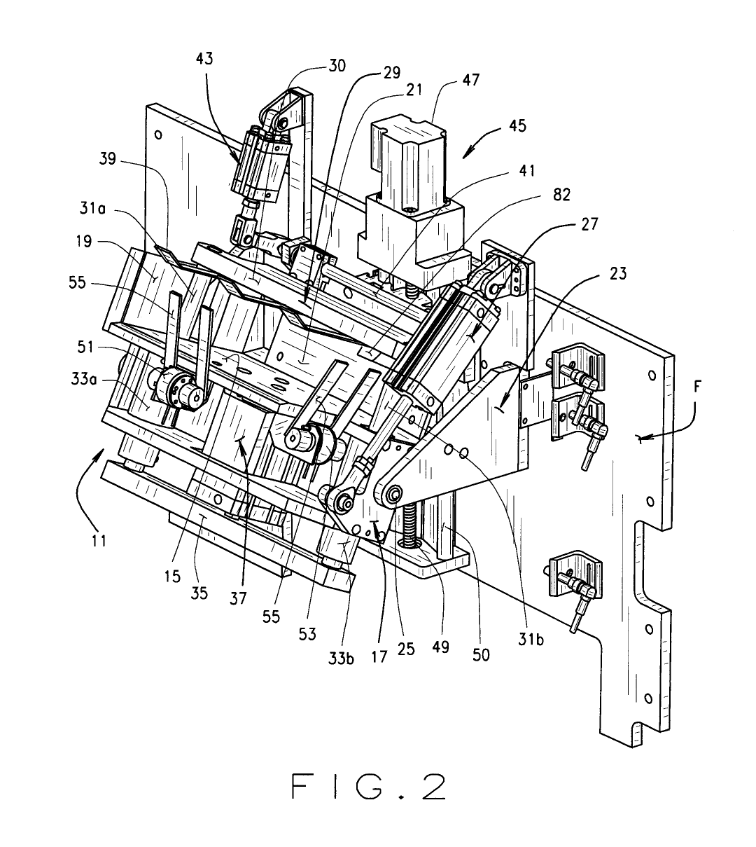

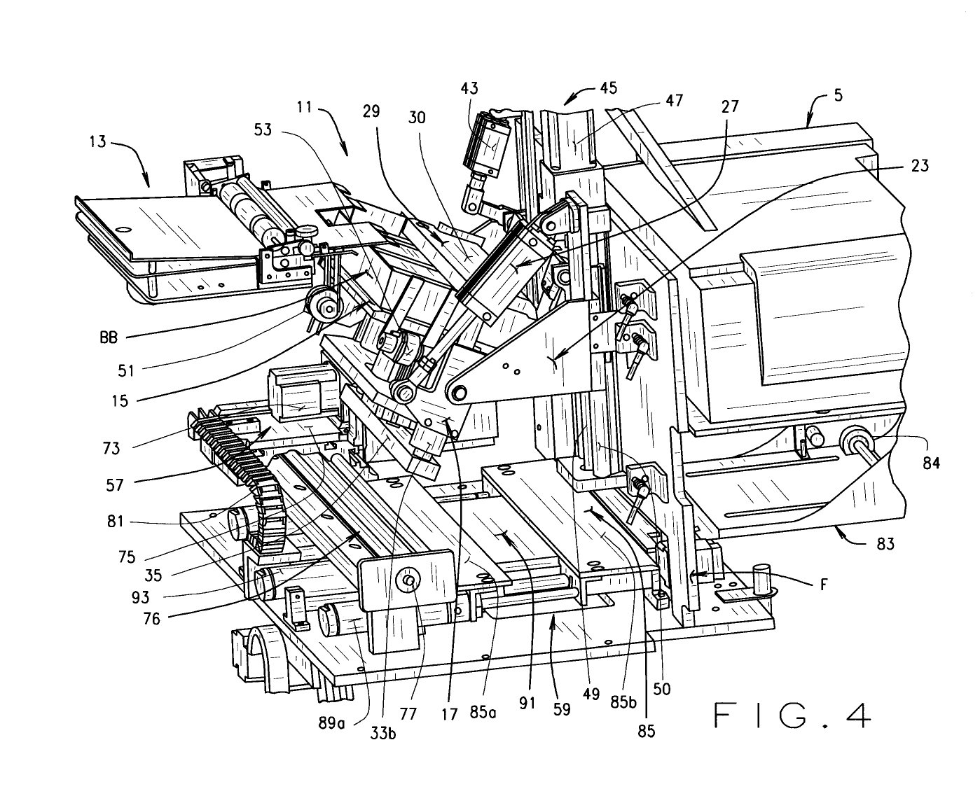

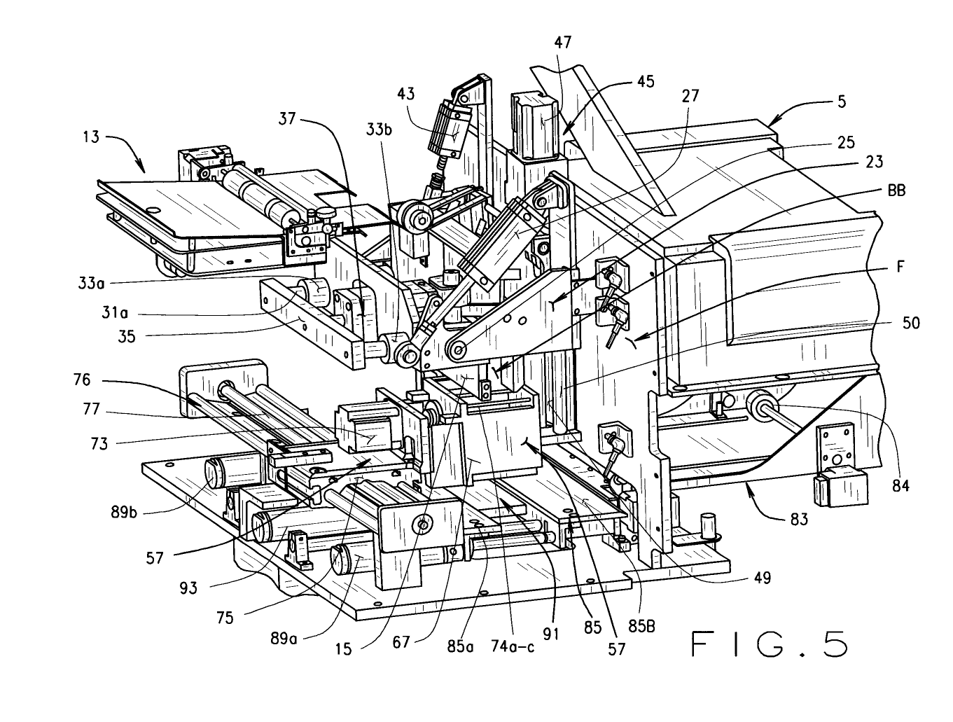

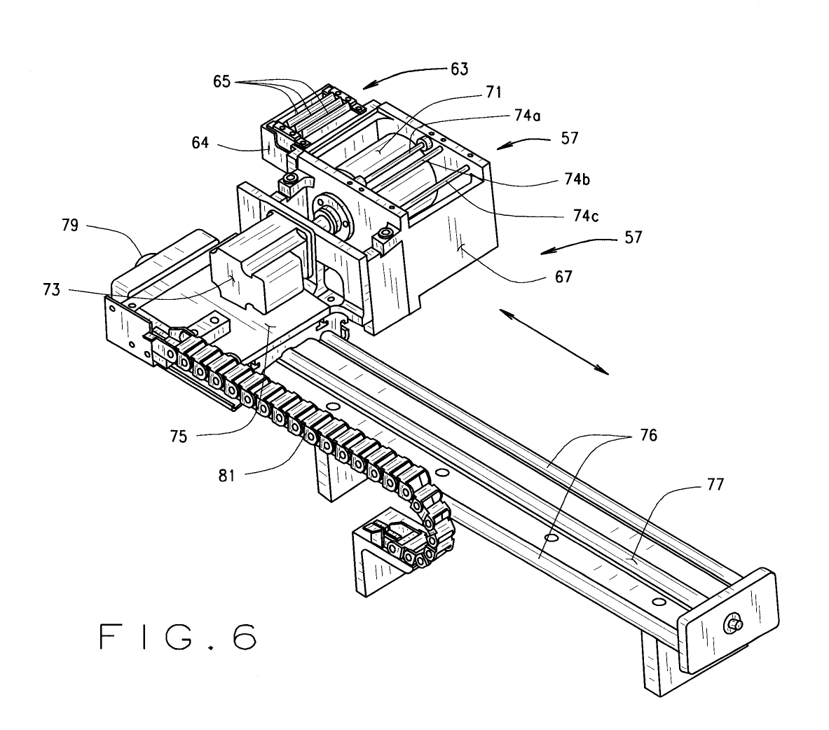

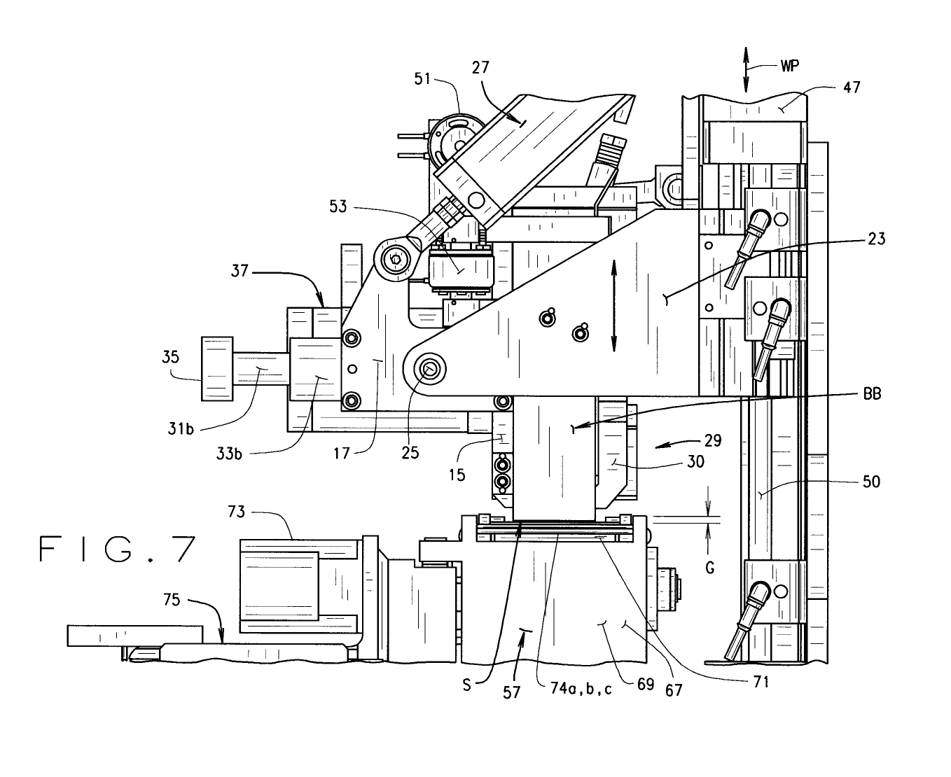

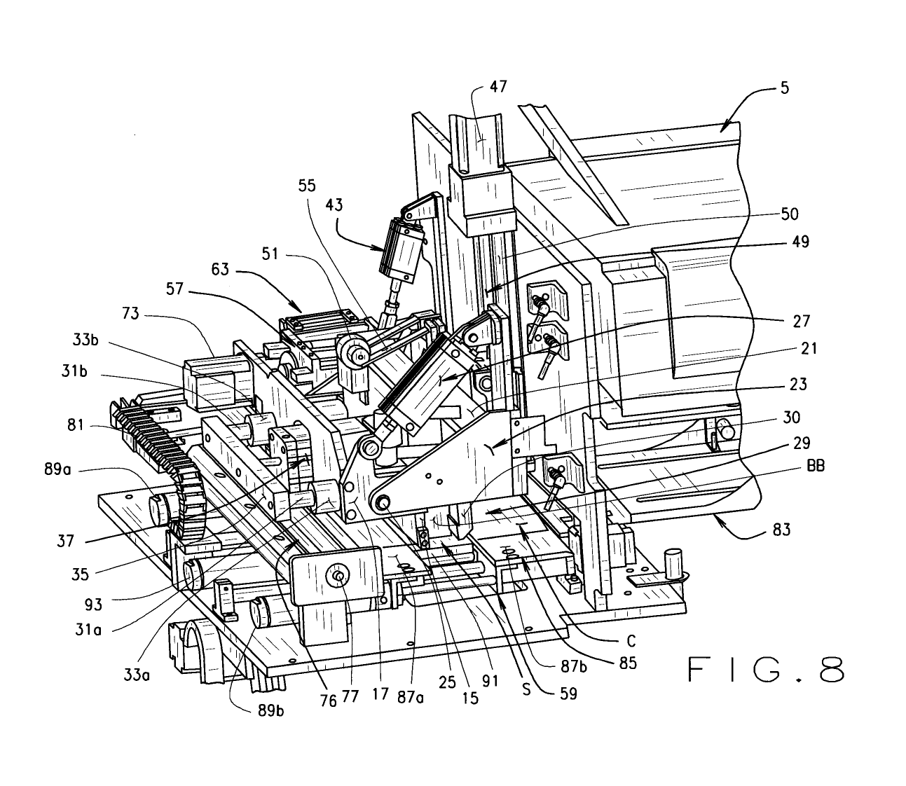

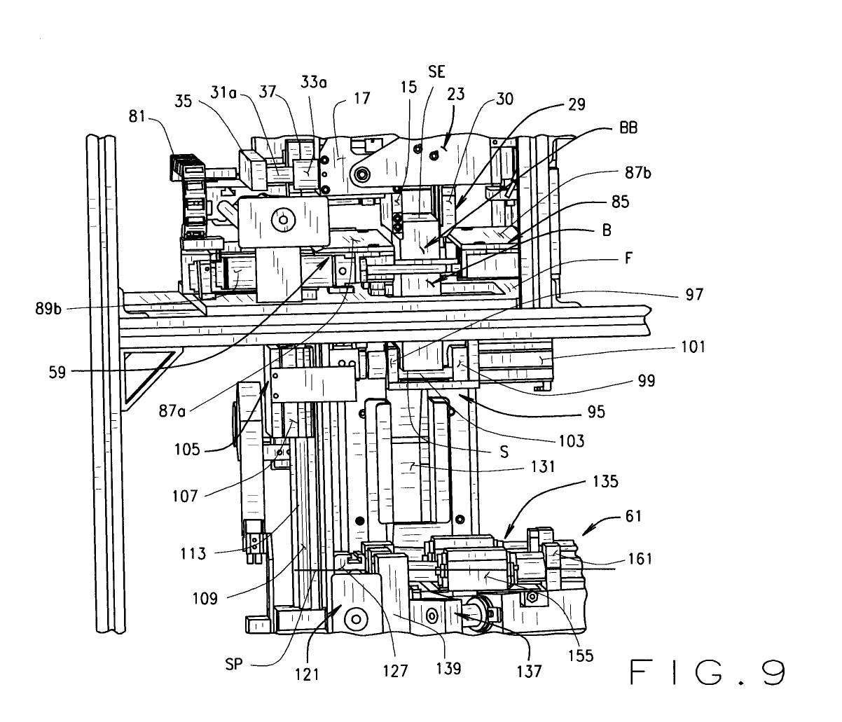

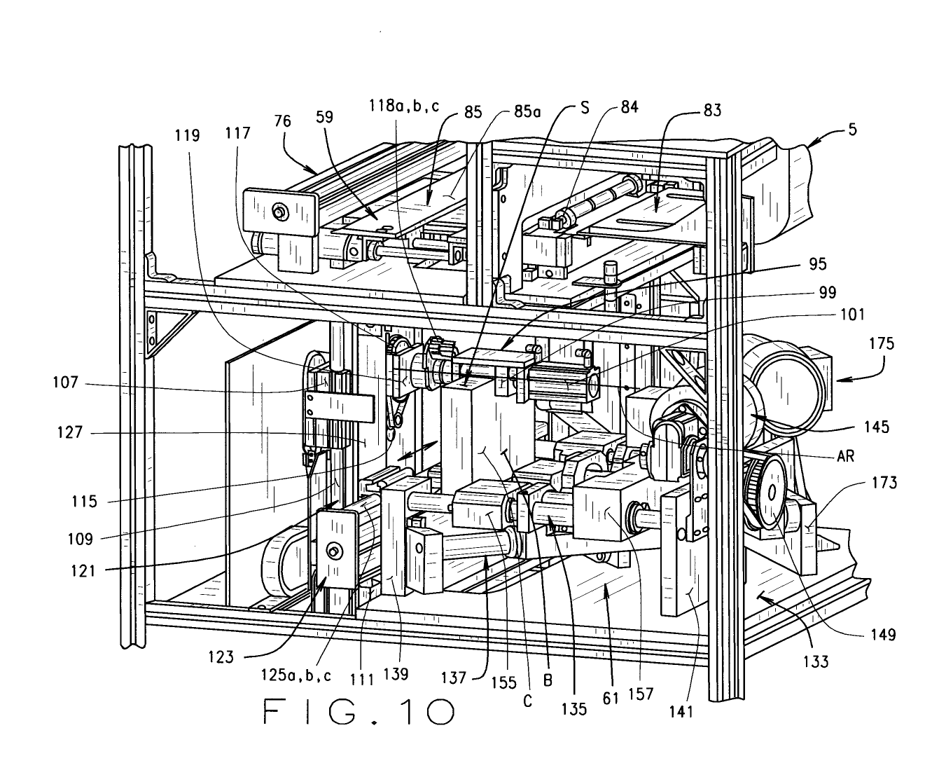

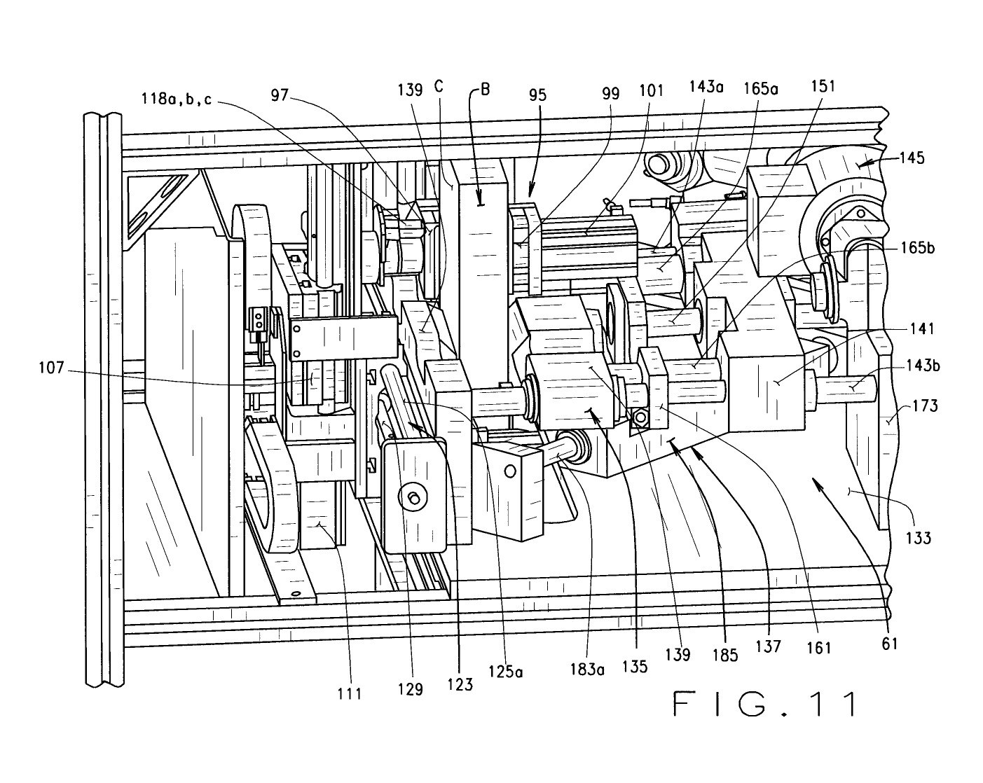

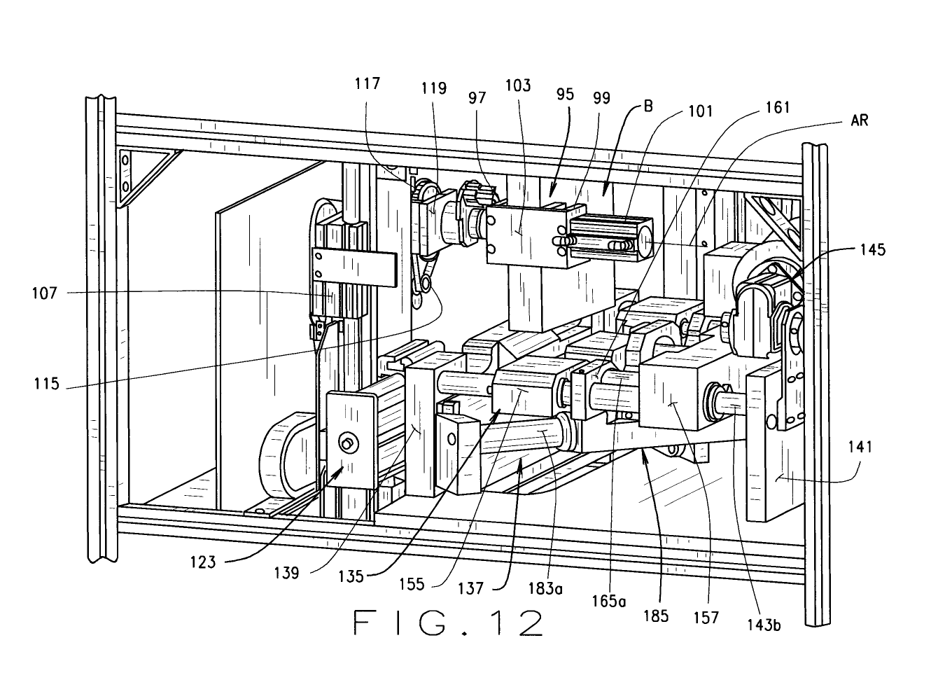

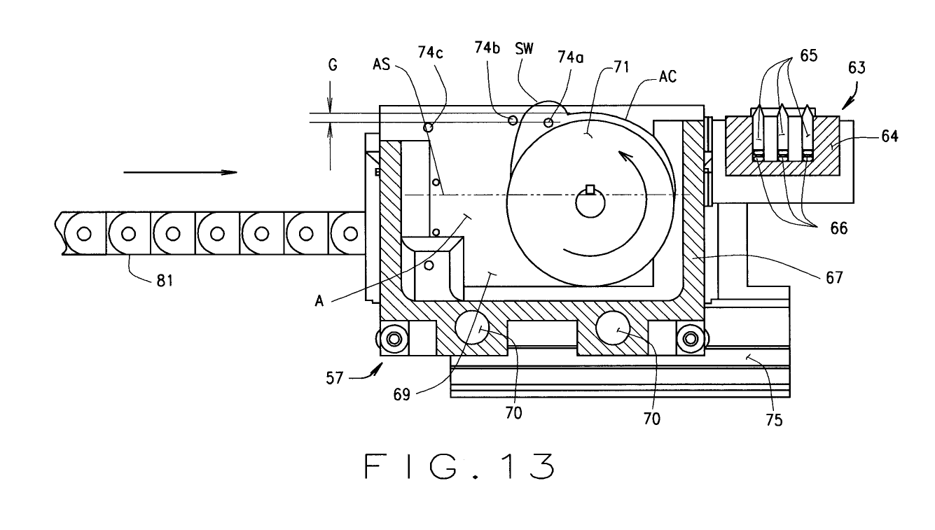

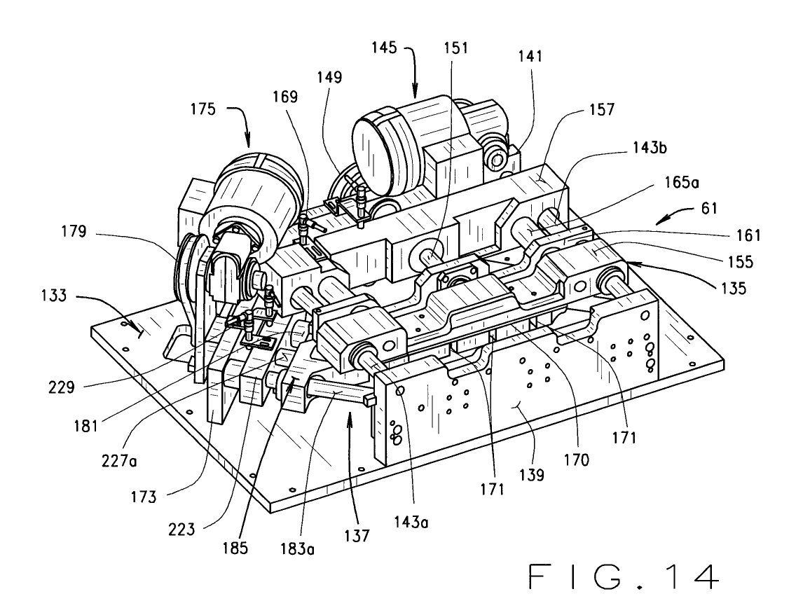

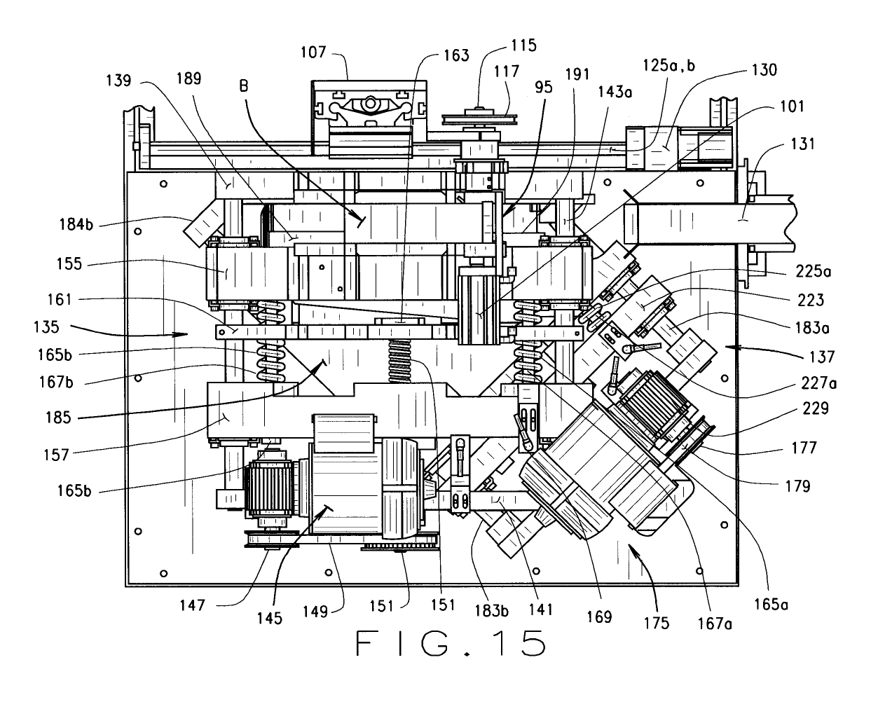

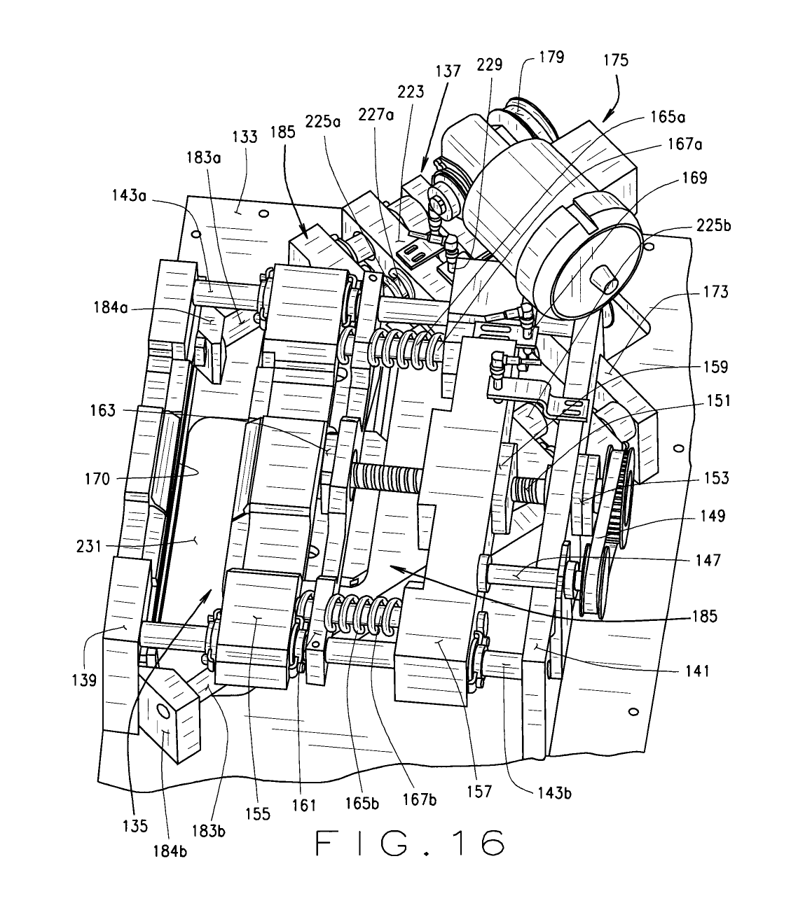

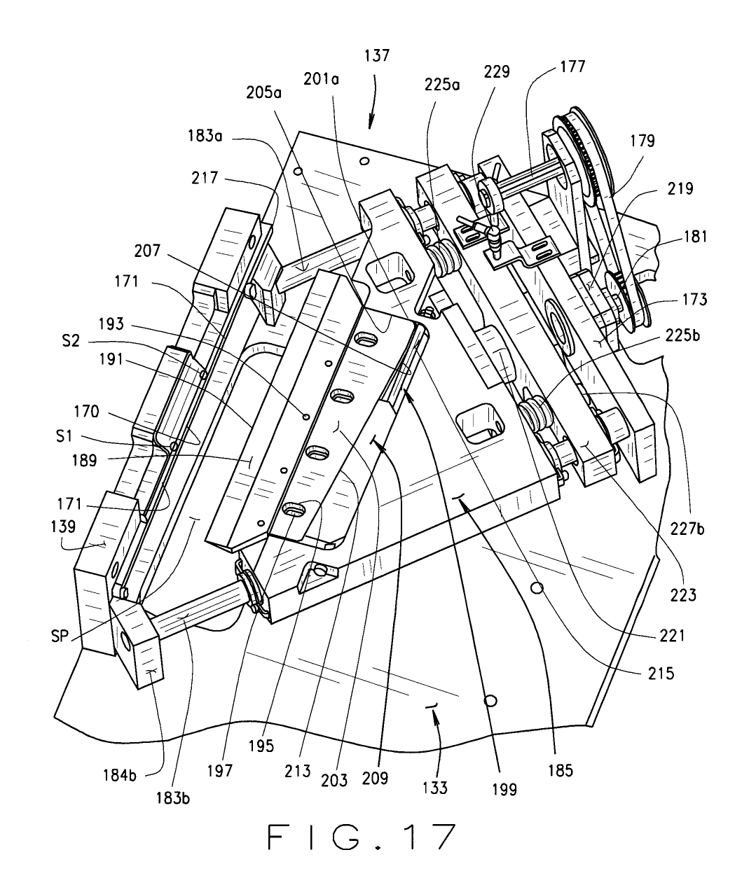

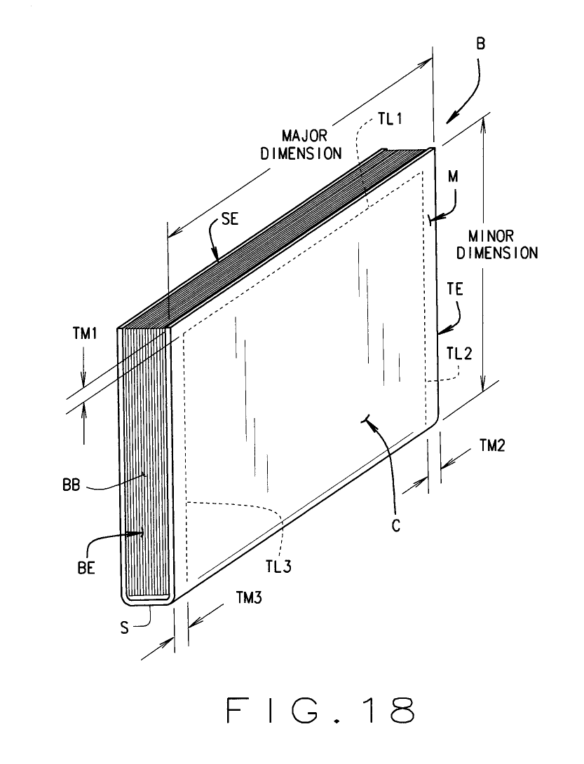

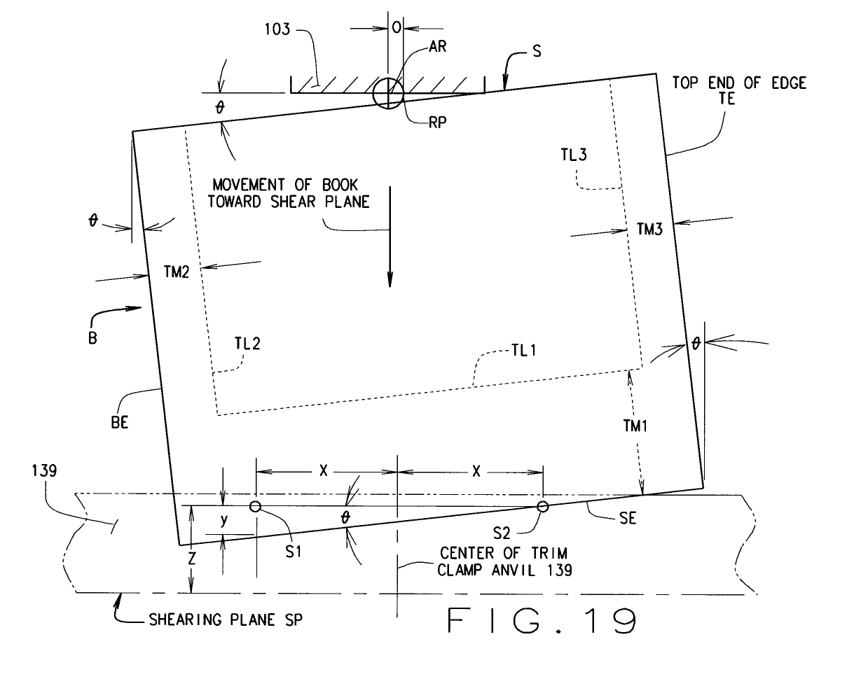

Referring now to the drawings, FIGS. 1-17 are the drawings from my above-noted U.S. patent application Ser. No. 12/576,923, which, as noted, is herein incorporated by reference in its entirety. However, certain portions of this '923 application most germane to the instant disclosure herein are also described below with certain additional disclosure added so as to more particularly describe the present disclosure.

As shown in FIGS. 9-12 of the present disclosure, vertical drive 45 lowers the bound book B from the binding station 59 to the trimming station 61 where the spine S of the bound book is placed in a trimming index clamp, as generally indicated at 95. As shown in FIG. 9, this clamp has a fixed clamp jaw 97 and a movable clamp jaw 99 movable toward and away from the fixed jaw by means of a fluid cylinder 101, preferably an air cylinder. Between jaws 97 and 99, a bearing surface 103 is provided against which the spine S of the bound book B will rest during the trimming operation. With the spine of the book bearing against surface 103 (that is, with the spine S substantially coplanar with surface 103), and with clamp 95 gripping the book along its spine, the angular position θ of the spine S of book B in clamp 95 is “known” to the computer control system CS. Because the control system also knows the desired finished size of the book being trimmed and the margins M1. M2, and M3 (see FIG. 18) of the book B that must be trimmed from one or more sides of the book along trim lines TL1, TL2 and TL3 (as shown in FIG. 19) to result in the desired finished size, the computer control system thus knows how much of the book margins must be trimmed from one or more sides of the book to result in the finished book to be of the desired predetermined size. Also, as shown in FIG. 19, the computer control system initially assumes that the book B is positioned laterally within clamp 95 such that the center reference point RP of the book B located midway between the end edges of the book is in the same vertical plane as the axis of rotation AR of clamp 103, and the angular position θ of the spine relative to surface 103 is presumed to be 0°. However, as will be described below, the book B may be laterally offset relative to the clamp. Also, rather than the book being skewed relative to base 103 of indexing clamp 95 as shown in FIG. 19, the indexing clamp may be slightly rotated from its assumed angular position such that the same angular mis-positioning of the book relative to the shearing plane SP will result. As described herein, the system and method described herein will correct for both the angular mis-positioning of the book, whether due to the book being skewed in the indexing clamp or whether the clamp is angularly mis-positioned. It will also be understood that in accordance with this disclosure, the apparatus is not dependent of switches 118a-c to angularly position the edges of the book relative to the shearing plane, but rather the system and method described herein will accurately angularly position each edge of the book relative to the shearing plane.

As shown in FIGS. 9-12, trim indexing clamp 95 is vertically movable between its raised position (as shown in FIG. 9) in which the clamp 95 receives book B and lowered trimming position (as shown in FIGS. 10-12) in which the book is positioned in trimming station 61 so that predetermined amounts of the margins (i.e., trim margins M1, M2 and/or M3, as shown in FIG. 18) of the book may be trimmed from the side and ends of the book so as to produce a trimmed book of a predetermined finished (trimmed) size. The clamp 95 is so vertically driven by means of a vertical drive, as generally indicated at 105. This drive comprises a vertical slide body 107 movable (slidable) along a vertical track 109. This drive includes a stepper gearmotor 111, a drive screw 113 driven by motor 111 with the drive screw being threadably coupled to slide body 107 for effecting vertical movement of the slide body and indexing clamp 95 along track 109 so as to effect movement of the indexing clamp between its raised and lowered positions. Because motor 111 is a stepper motor under the control of computer control system CS, it can accurately position book B gripped by clamp 95 within the trimming station so that predetermined margins of the book may be trimmed in a manner as will appear.

As perhaps best shown in FIG. 12, indexing clamp 95 is rotatable about axis AR, preferably but not necessarily a horizontal axis, by means of an indexing motor 115, preferably a stepper motor, under control of computer control system CS. The motor 115 is carried by vertical slide body 107. The output shaft of motor 115 is coupled to indexing clamp 95 by a timing belt and pulley speed reducing arrangement, as indicated at 117. The indexing clamp is rotatably mounted in and cantilevered from a rigid bracket 119 carried by the vertical slide body so that upon actuation of motor 115, the indexing clamp 95 may be rotated about the above-noted horizontal axis AR so as to accurately angularly position the margins of the bound book to be trimmed relative to the trimming station 61 so that the trimmed margins of the book will be “square”, that is the trimmed ends of the book will be substantially perpendicular to the trimmed front side of the book opposite spine S. As indicated at 118a, 118b, and 118c, switches are mounted relative to the horizontal rotational axis of indexing clamp 95 for stopping rotation of the indexing clamp at a first predetermined rotary position so as to position a first side of the book to be trimmed, and then for stopping rotation of the indexing clamp at second rotary position for trimming a second side of the book, and then for stopping rotation of the indexing clamp at a third rotary position for trimming a third side of the book so that two sides of the book (i.e., the top and bottom edges of the finished book) are perpendicular to the spine S and the longitudinal side parallel to the spine.

As generally indicated at 121 in FIGS. 10-12 and 15, a lateral, horizontal drive is provided for moving indexing clamp 95 in lateral, horizontal direction relative along a horizontal track 123 relative to the trimming station 61. Track 123 has spaced horizontal guide rods 125a, 125b on which are mounted a slide carriage 127. A horizontal drive screw 129 is rotatably mounted between guide rods 125a, 125b and is rotatably driven by a stepper motor 130 (See FIG. 12) located on the end of the drive screw opposite from that shown in FIGS. 10-12. This drive screw is threadably coupled to carriage 127. It will be understood that this last-mentioned stepper motor is similar to motor 47 and is under the control of computer control system CS. Thus, index clamp 95, while gripping book B along the spine of the book, may move the book B laterally relative to the trimming station as required so as to accurately position the book within the trimming station 61 so that three edges or sides of the book may be trimmed and so that a finished book of a predetermined finished size is produced. Further, after trimming of the book is complete, the index clamp 95 may be moved laterally so as to deposit the bound and trimmed book in a discharge chute 131 for discharge from apparatus 1.

It will be appreciated that because the rotary drive motor 115, vertical drive motor 111, and lateral drive motor 130 are stepper motors under the control of computer control system CS, because stepper motors 111 and 130 drive screws, and because rotary drive stepper motor 115 rotates the indexing clamp 95 by a speed reducing timing belt and pulley arrangement 117, these stepper motors and their respective drives can accurately position the book relative to the shearing plane SP. Such stepper motors are typically provided with an encoder (not shown) that has a predetermined number of counts for each revolution of the drive shaft of the motor. For example, these stepper motors may have 2048 counts for each revolution of its drive shaft and for each revolution of the drive screw. The drive screws for the vertical and lateral drive may have a pitch (i.e., the distance between successive threads on the drive screw) of 0.25 inches (6.35 mm.). Thus, these stepper motors and their respective drive screws may have a resolution of 0.25 inches/2048 counts=0.000122 inches (0.0031 mm.) for each count. As shown, stepper motor 115 rotating the indexing clamp 95 rotates the clamp utilizing a speed reducing timing belt and pulley arrangement 117, as shown in FIG. 10. If, for example, this speed reducing belt and pulley arrangement has a ration of 5:1, and if the stepper motor 115 has 2048 counts/revolution, the angular resolution of the drive 115, 117 to control the angular orientation of indexing clamp 95 and the book B held thereby is about 0.0351°/count. In this manner precise control of the position of the book is controlled by computer control system CS.

As noted in the above Background, with book trimming apparatus as described above, problems have occurred if the book is not properly positioned in index clamp 95. Specifically, if the spine S of the book is not in coplanar contact with bearing surface 103 of the clamp 95, the spine of the book and hence the book itself, may be angled with respect to clamp 95. Of course, when such an angle is present and when the clamp 95 positions the first side or edge within trimming station 61 to trim a predetermined amount from the edges or sides of the book, the edges of the trimmed book may not be orthogonal to one another. Also, if the book is not properly laterally positioned in clamp 95 so that the center reference point RP of the book is substantially in register with the axis of rotation AR, the book is laterally offset by the amount O (as shown in FIG. 19) from the axis of rotation AR of the clamp, and the margins trimmed from top and bottom end edges of the book may vary by the amount of the offset and this not result in the book having its desired trimmed dimensions.

To overcome these problems, and in accordance with this disclosure, a pair of spaced sensors, as indicated at S1 and S2, is mounted on anvil 139 of trim clamp 135. The sensors are mounted on anvil 139 (or at another specified location) a known lateral distance from one another and are mounted a known distance from the shearing plane SP of shear blade 189 for sensing the position of the lowermost edge of the book B as the book is lowered into trim clamp 135. Sensors S1, S2 are preferably centered on anvil 139 and are spaced such that both sensors will sense each edge of the book B as the book is lowered into the trim clamp. Because the side edge SE of the is often trimmed before the end edges thus narrowing the book to its trimmed width before the ends of the book are trimmed, the sensors S1 and S2 must not be spaced from one another a distance greater than the minimum width of the trimmed book. It will be understood that if the book block is printed on, for example, 8½×11 standard size paper stock, the finished book may be trimmed to much smaller finished dimensions, for example 5 (width)×8 (height) or smaller. Preferably, but not necessarily, the spacing between sensors S1 and S2 should no greater than about 80% of the smallest book width to be trimmed.

Sensors S1 and S2 may be a photocell sensors that emit a narrow, focused light beam spanning the opening of trim clamp 135 between anvil 139 and clamp jaw 155 with such light beam being reflected back to the sensor when an edge of the book B intercepts the light beam thus indicating that an edge of the book to be trimmed has been sensed by the sensor. Thus, these sensors will generate an output signal indicative of the sensing of an edge of the book being proximate to the sensor. As the book is lowered into the trim clamp, the lowermost edge of the book will break the beams of each of the sensors and thus will generate output signals corresponding to the position of the lowermost edge proximate the sensors S1 and S2. One such sensor that has worked well for sensors S1 and S2 is a model SSF-OP-OA fiber amplifier photocell commercially available from www.AutomationDirect.com of Cummings, Ga. Such sensors are capable of precisely detecting the presence of an edge of the book to within about a few 1/1000ths of an inch and are repeatedly from book to book.

As illustrated in FIG. 19, if the spine S of book B is gripped by clamp 95 such that the spine S is at an angle θ with respect to bearing surface 103, the lowermost edge of the book (e.g., side edge SE) will be disposed at a similar angle θ relative to sensors S1 and S2 (and relative to shearing plane SP). Thus, with the book disposed at angle θ, as a first lowermost edge is moved toward the shearing plane the presence of this angled book edge will actuate one of the sensors (for example, S1 as shown in FIG. 19) before the other thus generating an output signal to computer control system CS that the book is disposed at an angle relative to the shearing plane. As shown in FIG. 19, each of the sensors S1 and S2 are spaced equidistantly from the centerline CL1, as indicated by distance x. Preferably, sensors S1 and S2 are mounted on anvil 139 and are spaced equidistantly from the center of the anvil inboard of slots 171 on clamp member 161, which slots are intended to receive the bound edge of the book spine S as the top and bottom edges of the book are trimmed. Further, the sensors are located the same distance above shearing plane SP, as denoted by z in FIG. 19.

Thus, after a first sensor (e.g., S1) detects the first book edge (e.g., side edge SE) being lowered into trim clamp 135, the continued movement of this first edge of the untrimmed book B toward shearing plane SP will actuate or trip sensor S2 at some time after sensor S1 is tripped. It will be understood that because the book is lowered toward the shearing plane by vertical drive 105 via stepper motor 111 under the control of computer control system CS, the computer control system will “know” the vertical position of the lower edge of the book when the signal from the first sensor S1 is generated and the vertical position of the book when sensor S2 is tripped. This difference in distance from shearing plane SP is indicated by “y” in FIG. 19. Because the spacing between the two sensors S1 and S2 is known (i.e., x+x=2x, as shown in FIG. 19) and because the distance y is determined by the computer control system, the angle can readily be determined by the trigonometric relation arctan y/2x=θ. Further, the direction that the book is skewed in clamp 95 is determined by which sensor S1 or S2 is tripped first by the lower edge of the book.

By way of example, if the book B is mis-positioned at an angle θ=2.5° relative to bearing surface 103 of indexing clamp 95 in the direction shown in FIG. 19 such that this angle is greater than a predetermined limit or angle (i.e., the measured angle is greater than a small angle that would not be visually perceptible in the finished book), and if the rotary drive heretofore described having a resolution of 0.0351°/count for stepper motor 115 is used, it would require stepper motor 115 to rotate the index clamp approximately 71 counts in counterclockwise direction (as shown in FIG. 19) to reposition the book so that its lower edge SE was substantially parallel to the shearing plane. Of course if the sensor S2 is tripped before sensor S1, that will indicated that the indexing clamp must be rotated in clockwise direction so as to correct or compensate for this angularity inaccuracy. As will be appreciated, by so rotating the indexing clamp to correct for the angularity, the top and bottom end edges TE and BE of the book are also simultaneously adjusted to be parallel to the shearing plane upon the computer control system CS effecting rotation of the book either 90° or 180° from the corrected position of the book. It will be noted that this system of relying on the sensors S1 and S2 to determine the angular position of the first edge to be trimmed and then relying on the accuracy of the stepper motor 115 to rotate the book either 90° or 180° to trim the top and bottom ends of the book removes the reliance on the above-described switches 118 a-c to stop rotation of the book at the positions to trim the top and bottom edges.

It will be further appreciated that while the bound, but untrimmed book B is intended to be laterally placed in indexing clamp 95 in a known position with the midpoint of spine S (as indicated by the center reference point RP, as shown in FIG. 19) being substantially in register with rotary axis AR, it has been found that the book may be shifted from its intended lateral position in the indexing clamp, which will result in an improper amount being trimmed from the top and bottom edges TE and BE, respectively, of the book. In accordance with the present disclosure, the sensors S1 and S2 and the computer control system CS are able to check or verify that the book is properly laterally positioned with respect to the axis of rotation AR of indexing clamp is substantially in register with the center reference point RP of the book. If the book is laterally mis-positioned in the indexing clamp, there will be an offset O between the reference point RP and the axis of rotation AR, as shown in FIG. 19. In accordance with this disclosure, sensors S1 and/or S2 and computer control system CS will check for such offset and the computer control system will compensate for any such lateral mis-positioning of the book by appropriately raising or lowering the end edges of the book relative to the shearing plane SP so as to align the trim lines TL2 and TL3 with the shearing plane as one or both of the end edges of the book are lowered into the trim clamp 135.

As noted, the book block BB is typically printed on standard size sheets of paper. Typically in the United States, the book block is printed on 8½×11 size paper. However, in other countries other standard size paper stock may be used (e.g., A4 size paper). In this manner, the finished size of the book can be either the full size of the standard paper (with no trimming), or predetermined amounts may be trimmed from the side edge SE and from the top and bottom end edges TE and BE so as to result in a finished book of a predetermined size smaller than the standard size stock paper. As shown in FIG. 19, side edge SE may have a predetermined trim line TL1 associated therewith and top and bottom end edges may have respective trim lines TL2 and TL3 associated therewith such that if the book is trimmed along these trim lines the finished book will have predetermined finished dimensions.

It has been found that such standard size paper is substantially less expensive than custom cut paper for use as the book block stock. Even if custom cut paper is used for the book block BB, it has been found that it is still desirable to trim the book along its sides so that that the appearance of the finished book is enhanced. Thus, for most books, it is necessary or desirable to trim the book to a predetermined finished size. Such standard size (e.g., 8½×11) paper is typically precision cut such that the major edges of the paper (see FIG. 18) are parallel to one another and so that the minor edges are orthogonal to the major edges. Thus, the size of the sheets and the orthogonal relation of the sheet edges do not appreciably vary. As the sheets for the book block BB are printed and delivered to accumulator 11 (as shown in FIG. 3), each sheet is preferably tapped by page tappers 51 and 53 so as to insure that one of the major edges of each sheet of paper is contact with stop plate 21 and so as to insure that one of the minor edges of each sheet is in contact with end plate 19. It will be understood that these page tappers 51 and 53 help overcome any static charge carried by the sheets as they are delivered from the printer to the accumulator 11 and help insure that the book block is uniformly formed. Further, with each of the sheets of the book block so positioned, the book block remains in this position as it is securely clamped to accumulator bed 15 by accumulator clamp 29. The book block is thus firmly held by the accumulator clamp 29 in binding station 59 while cover C is adhesively bound to the spine of the book block. However, as shown in FIG. 9, while the cover C is being clamped on to the book block proximate the spine S by binding clamp 85, accumulator clamp 29 releases its grip of the book block BB proximate spine S and moves upwardly along the book block so as to re-grip the book block proximate the side edge SE of the book block parallel to the spine (as shown in FIG. 9). After binding of the cover to the book block is complete, binding clamp 85 releases the book and the binding jaws 87a, 87b are opened so that the accumulator clamp may lower the now bound book B downwardly through the binding station to “hand off” the book to indexing clamp 95.

Indexing clamp 95 is preferably laterally positioned by lateral drive 121 so that its rotary axis AR is in position to be in substantial vertical alignment with the center reference point RP of the book B. For example, if the book block BB is printed on 8½×11 stock and if the major dimension forms spine S, the center reference point RP will be 5.50 inches from the minor edge of the book block that was formed against side plate 19 in the accumulator. However, it has been found that in some instances, the indexing clamp may not be in its intended lateral position or that the book has laterally shifted in accumulator clamp 29 as it is moved to the indexing clamp. In such cases, there may be a slight lateral offset O, as shown in FIG. 19, between the lateral position of the axis of rotation AR of the indexing clamp and the center reference point RP of the book. In practice, this lateral offset O has been found to generally be less than 0.25 inches (6.35 mm.), but it will be understood that larger offsets may be accommodated by the apparatus and method herein disclosed.

While in general, it is preferred that the angularity of the book spine relative to the bed 103 of indexing clamp 95 (as indicated by the angle θ, as shown in FIG. 19) be corrected before correcting for the above-described lateral offset O, it will be understood that the lateral offset can be corrected before the angularity of the book is corrected. As shown in FIG. 10, after the book B is gripped by indexing clamp 95 along the spine S of the book, the indexing clamp is rotated by rotary drive stepper motor 115 approximately 180° to as to present the side edge SE of the book toward shearing plane SP and the book is then lowered into trim clamp 135. As described above, as the book is lowered into the trim clamp, the lower edge of the book will actuate sensors S1 and S2 and the angularity error of the book relative to the indexing clamp may be corrected. The book is then lowered so as to position the trim line for this first edge to be trimmed (for example, trim line TL1 for side edge SE) in register with (i.e., to correspond with) the shearing plane SP so that the shearing blade 189 may shear the book along this trim line.

The trimming clamp 135 is released and the book B is then raised and rotated, for example, 90° so as to position an end edge (e.g., bottom edge BE) to be trimmed. The book is then re-lowered into the trim clamp 135 under the control of computer control system CS. As the lower edge of the book (end edge BE) moves into register with one or both of the sensors S1 or S2, the presence of the bottom edge acutates the sensor and again generates an output signal to computer control system CS indicating the actual vertical position of this lower edge of the book relative to the shearing plane SP. The computer control system has information indicating the nominal (or expected) position of this lower end edge relative to the shearing plane if there is no offset O present between the reference point RP and the axis of rotation AR. If there is such an offset, the sensor S1 or S2 will be actuated by the lower end edge at a location different than if no offset was present. The computer control system then compares the signal generated by the lower end edge as it actuates one (or both) of the sensors with the nominal position for that end edge and such that the difference between the actual and the nominal position corresponds to the offset O. The computer control system will then effect movement of the vertical drive 105 to compensate for this offset. Of course, if the sensor senses the actual position of this lower end edge BE before the time the nominal position of that end edge should have been sensed, that will indicate that the lower edge BE is offset toward the shearing plane SP by the amount of the offset O. In order to correctly position the trim line TL2 for the bottom edge BE in register with the shearing plane, the computer control system CS will subtract the amount of the offset O from the nominal vertical position the lower edge. With the trim line TL2 for the bottom edge BE in register with the shearing plane SP and with the book clamped by trim clamp 135, the shear blade 189 is actuated to effect trimming of the book along trim line TL2.

After trimming of the lower end edge BE, the trim clamp 135 is released and the book B is raised clear (or partially clear) of trim clamp and the book will be rotated approximate 180° so as to present the other end edge TE to be trimmed. Since the computer control system already “knows” the amount of the offset O, the computer control system can effect the proper placement of the trim line TL3 in register with the shearing plane without measurement by the sensors S1 and S2. However, those skilled in the art will understand that the sensors can be used in the manner described above to determine or to check for the offset as this other end edge is moved toward the shearing plane.

While the above trimming operations have been described as trimming the side edge SE first, those skilled in the art will recognize that the angle θ and the offset O may be likewise corrected if one of the end edges BE or TE is trimmed first. It will be further understood that upon trimming the major and the minor edges or sides of said book (as shown in FIG. 18) that the order in which the edges are trimmed is not critical to this disclosure. Upon the presentation of a “fresh” edge (i.e., an untrimmed edge) for trimming, it is assumed that it is either parallel to the spine S (as is the case for side edge SE) or perpendicular to the side edge (as is the case for end edges TE or BE). If an edge is presented “squarely” to both sensors 51 and S2 (that is, if an edge trips both sensors at substantially the same time), then it is known that the edge is not oriented at an angle θ relative to the shearing plane SP. However, if one of the sensors 51 or S2 is actuated by the edge before the other, then that is edge is either oriented at an angle relative to the indexing clamp (or book holder) 95 or the holder is not in the proper angular orientation so as to present that edge to the shearing plane SP. Thus, if the two sensors are actuated at different times, the computer control system CS may calculate the proper angular position of that edge in the manner described above and the computer control system will effect the rotation of the book accordingly so as to compensate for the improper angular orientation of the book edge relative to the shearing plane, in the manner heretofore described. Then, the computer control system re-calculates where the resulting now parallel edge is in relation to the shearing plane SP. This determination of where the resulting now parallel edge is in relation to the shearing plane by either moving the book edge clear of the sensors and then moving it toward the sensors so both sensors will be tripped simultaneously or the computer control system so as to indicate to the computer control system where this edge of the book is relative to the shearing plane after the angle θ has been corrected, or the computer control system can calculate the position of the book edge relative to the shearing plane after the angle θ has been corrected or compensated for. Then, the computer control system effects the movement of this now parallel edge toward the shearing plane the known distance from the shearing plane, as denoted by dimension “z” in FIG. 19, plus the amount of the respective trim margin (e.g., margin TM1, TM2, or TM3, as shown in FIG. 18) for that edge of the book, which is known to the computer control system.

As described in my above-noted U.S. patent application Ser. No. 12/576,923, a preferred computer control system CS may be a programmable logic controller (PLC), such as a model IC200UDD064 VersaMax Micro PLC commercially available from GE Fanuc of Charlottesville, Va.

It will be understood that when the terms “orthogonal”, “parallel”, “perpendicular”, “angularity difference”, “offset”, “finished dimension” or other dimensional terms used in this disclosure to describe the trimming of book B are not meant to mean that extreme accuracy or precision is inferred by these terms. Instead, it is intended that the sides of the book should be sufficiently orthogonal, perpendicular or parallel, or should conform to predetermined dimensions such that a finished book will have a good appearance and will be salable when compared to similar books produced by other conventional manufacturing or printing processes, as opposed to the print on demand process described herein.

As various changes could be made in the above constructions without departing from the broad scope of the disclosure, it is intended that all matter contained in the above description or shown in the accompanying drawings shall be interpreted as illustrative and not in a limiting sense.

1. Apparatus for determining and correcting an angularity difference between an edge of a book to be trimmed and a shearing plane of a trimming blade and the intended angularity of such edge relative to said shearing plane, said book being generally rectangular and having a spine, a side edge opposite said spine and being generally to parallel to said spine, and two end edges extending generally orthogonally to said side edge and to said spine, said book edges each having a predetermined trim line associated therewith such that if each of said book edges is trimmed along its respective trim line the finished book will be of a predetermined finished size with the end edges of the book being substantially perpendicular to said spine and to said side edge, said book being movable toward and away from said shearing plane by a drive controlled by a computer control system and being rotatable about a rotary axis by a rotary drive controlled by said computer control system, said apparatus comprising a pair of sensors stationaryily mounted at a known distance relative to said shearing plane for sensing a first edge of said book proximate each said sensor as said first edge is moved toward said shearing plane, said sensors being spaced apart from one another a known distance and each of said sensors generating an output signal indicative of said first edge being proximate each said sensor so that upon said first edge being sensed substantially simultaneously by both of said sensors said output signals indicating to said computer control system that said first edge is substantially parallel to said shearing plane and so that if one of said output signals is generated before the other indicating that said first edge is oriented at an angle relative to said shearing plane such that said computer control system effects operation of said rotary drive to correct for said angle so that said trim line associated with said first edge may be positioned substantially in register with said shearing plane.

2. Apparatus as set forth in claim 1 wherein said first edge is said side edge.

3. Apparatus as set forth in claim 2 wherein said computer control system is provided with information so as to position each of said end edges relative to said shearing plane such that the respective trim line for each of said end edges is in register with said shearing plane, wherein said book has a reference point along its spine approximately midway between said end edges of said untrimmed book such that if said book is properly laterally positioned relative to said rotary axis said reference point is in substantial lateral registration with said rotary axis and such that if said book is laterally mis-positioned relative to said rotary axis said reference point is offset from said rotary axis such that each of said end edges will be trimmed along a line other than its intended trim line thus resulting in an improper amount will be trimmed from said end edges, said computer control system being provided with information corresponding to a theoretical position of where one of said end edges of said untrimmed book should be in relation to said shearing plane when said one end edge is sensed by at least one of said sensors if there is substantially no offset, and wherein upon the actual position of said one end edge being sensed by said at least one sensor generating an output signal corresponding to said actual position, said computer control system comparing said actual and said theoretical positions of said one end edge and compensating for said offset such that said book is positioned relative to said shearing plane so that said one end edge may be trimmed along its respective trim line.

4. Apparatus as set forth in claim 3 wherein after said one end edge is trimmed said book is rotated by said rotary drive so as to orient said other end edge toward said shearing plane, said book being moved by said drive toward said shearing plane, said computer control system having information corresponding to a theoretical position of where said other end edge of said book should be in relation to at least one of said sensors if there is substantially no said offset, and wherein upon said at least one sensor sensing the actual position of said other end edge and generating an output signal corresponding to the actual position of said other end edge, said computer control system comparing said actual and said theoretical positions of said other end edge and compensating for said offset such that said book is positioned relative to said shearing plane so that said other end edge may be trimmed along its respective trim line.

5. Apparatus as set forth in claim 2 wherein after said side edge is trimmed, said book is rotated approximate 90° by said rotary drive so as to position one of said end edges toward said shearing plane.

6. Apparatus as set forth in claim 5 wherein after said one end edge is trimmed, said book is rotated approximately 180° by said rotary drive and is moved toward said shearing plane by said drive, said computer control system compensating for said offset so that upon shearing of said other end edge may be trimmed along it respective trim line.

7. Apparatus for determining an angularity difference between a spine of a book to be trimmed and a shearing plane of a trimming blade in a trimming station and an intended angularity of said spine relative to said shearing plane and for correcting a lateral offset between an intended lateral position of said book held along its said spine for rotation about a rotary axis and the actual lateral position of said book held relative to said rotary axis, said book having a side edge opposite said spine and generally parallel to said spine, said book further having first and second end edges substantially perpendicular to said spine and to said side edge, said apparatus having a computer control system controlling operation of a rotary drive for rotating said book about said rotary axis so as to angularly position said side edge and said end edges relative to said shearing plane, each of said edges having a trim line associated therewith such that if each said edge is trimmed along said trim lines the trimmed book will have predetermined finished dimensions and the end edges will be substantially perpendicular to said spine and said side edge, said computer control system further controlling a drive that moves said book toward and away from said shearing plane, said trimming station having a trim clamp comprising a fixed anvil and a trim clamp member movable toward and away from said anvil between an open position in which said book may be placed within said trim clamp and a clamping position in which said book is held firmly by said anvil and said trim clamp member while said book is trimmed, said trimming station further comprising a shear blade moveable in said shearing plane toward and away from said anvil between a retracted position in which said shear blade is clear of a book held by said trim clamp and a shearing position in which said blade cooperates with said anvil for shearing through said book, said apparatus further comprising a pair of sensors mounted equidistantly from said shearing plane for sensing an edge of said book proximate each of said sensors as said book is moved toward said shearing plane, said sensors being spaced apart from one another a known distance, each sensor generating an output signal upon sensing the presence of a book edge proximate said sensor such that if said output signals are generated substantially simultaneously said output signals thus indicating that the edge to be trimmed is substantially parallel to said shearing plane and such that if one of said output signals is generated before the other thus indicating said angularity difference is beyond a predetermined limit so that said computer control system may effect operation of said rotary drive so as to rotate said book about said rotary axis to correct for said angularity difference so that said trim line for said edge to be trimmed is substantially in alignment with said shearing plane, and wherein said first edge is said side edge, and wherein after said side edge is trimmed, said rotary drive rotating said book so as to present one of said end edges to be trimmed, said drive then moving said book toward said shearing plane, said one end edge having a trim line associated therewith such that if said one end edge is trimmed along its respective trim line a predetermined amount of said book will be trimmed, and wherein as said one end edge is moved toward said shearing plane at least one of said sensors sensing said one end edge, said computer control system comparing the actual position of said one end edge as sensed by said at least one sensor to a theoretical position of said one end edge if said book is properly laterally positioned relative to said rotary axis with the difference between the actual and theoretical positions being approximately equal to said lateral offset, said computer control correcting for said lateral offset and effecting operation of said drive so as to position said one end edge trim line substantially in register with said shearing plane such that a predetermined amount will be trimmed from said other edge along said one end edge trim line.

8. Apparatus as set forth in claim 7 wherein after said one end edge is trimmed said book is rotated so as to orient the other of said end edges toward said shearing plane and is moved toward said shearing plane, said computer control system correcting for said lateral offset so that said other end edge is moved into substantial registration with its predetermined trim line.

9. Apparatus for trimming a book, said book having a spine, a side edge parallel to said spine and two end edges perpendicular to said spine, said side edge and said end edges each having a respective predetermined trim line associated therewith such that upon said book being trimmed along said trim lines said book will be of a predetermined finished size with said side edge being substantially parallel to said spine and with end edges being substantially perpendicular to said spine and side edge, an indexing clamp gripping said book along said spine, said indexing clamp being rotatable about a rotary axis by a rotary drive under the control of a computer control system and being movable toward or away from said shearing plane by a drive under the control of said computer control system for positioning said book at predetermined angular positions and at predetermined positions relative said shearing plane so that said side edge and said end edges of said book may be trimmed along their respective predetermined trim lines, said book having a reference point substantially at the midpoint of said spine and being preferably laterally positioned in said indexing clamp in a nominal lateral position with said reference point and said rotary axis being substantially in lateral registration with one another so that there is no substantial lateral offset between said reference point and said rotary axis, said book being held by said indexing clamp such that said spine and said side edge are substantially parallel to said shearing plane, said apparatus further having at least one sensor for sensing one of said end edges as it is moved toward said shearing plane and for generating an output signal corresponding to the actual position of said at least one end edge relative to said at least one sensor, said at least one sensor being located in a known position relative to said shearing plane, said computer control system comparing said output signal of said at least one sensor corresponding to said actual position of said one end edge relative to said shearing plane and a theoretical position of said one end edge relative to said shearing plane if no said offset is present with the difference between said actual and said theoretical positions being indicative of said offset, said computer control system compensating for such offset so that said book is positioned relative to said shearing plane so that said one end edge may be trimmed along its respective trim line.

10. Apparatus as set forth in claim 9 wherein after said one end edge has been trimmed said book is rotated about said rotary axis so as to present another untrimmed end edge toward said shearing plane, said drive effecting movement of said other end edge toward said shearing plane, and said computer control system compensating for said offset so that said other end edge may be trimmed along its predetermined trim line.

11. A method of trimming a book, said book having a spine, side edge generally parallel to said spine and end edges at each end of the book generally perpendicular to said spine and to said side edge, said method comprising the steps of:
a. gripping said book along its spine;
b. rotating said book so as to present a first one of said edges to be trimmed;
c. moving said book toward a shearing blade having a shearing plane along which said blade will trim an edge of said book;
d. sensing the position of said first edge relative to said shearing plane at two spaced locations equidistant from said shearing plane;
e. determining the angle of said first edge relative to said shearing plane; and
f. if said angle is greater than a predetermined allowable angle, rotating said book relative to said shearing plane so as to align a predetermined trim line associated with said first edge to be substantially in register with said shearing plane.

12. The method of claim 11 wherein said first edge is said side edge, wherein said book is rotatable about a rotary axis, and wherein said spine has a reference point approximately midway between said end edges, said method further comprising the steps of:
g. rotating said book so as to present one of said end edges to be trimmed;
h. moving said one end edge toward said shearing plane;
i. sensing the position of said one end edge relative to said shearing plane;
j. comparing the sensed position of said one end edge to a nominal position of said one end edge where said reference point substantially laterally coincides with said rotary axis, with the difference between said sensed position and said nominal position indicating an offset between the actual position of said book and said nominal position;
k. moving said first edge relative to said shearing plane so as to compensate for said offset so that a predetermined trim line for said one end edge is substantially in register with said shear plane; and
l. trimming said one end edge along its respective said trim line.

13. The method of claim 12 further comprising the steps of:
m. after said one end edge is trimmed, rotating said book so as to present the other of said end edges to be trimmed;
n. moving said other end edge relative to said shearing plane so as to compensate for said offset so that a predetermined trim line for said other end edge is substantially in register with said shearing plane; and
o. trimming said other end edge along its respective said trim line.

14. A method of trimming a book, said book having a spine, side edge generally parallel to said spine and end edges at each end of the book generally perpendicular to said spine and to said side edge, said method comprising the steps of:
a. gripping said book along its spine with said spine being in a known angular position;
b. rotating said book about a rotary axis so as to present one of said end edges to be trimmed;
c. moving said book toward a shear blade having a shearing plane along which said blade will trim said one end edge;
d. sensing the position of said one end edge relative to said shearing plane;
e. comparing the sensed position of said one end edge to a nominal position of said one end edge where a reference point is substantially in a known position with respect to said rotary axis, with the difference between said sensed position and said nominal position indicating an offset between the actual position of said book and said nominal position;
f. moving said one end edge toward or away from said shearing plane so as to compensate for said offset such that a predetermined trim line for said one end edge is substantially in register with said shear plane; and
g. trimming said one end edge along its respective said trim line.
